(19) United States
(12) Patent Application Publication
(10) Pub. No.: US 2025/0163586 A1
(43) Pub. Date: May 22, 2025

(54) Method for operating an electrolysis plant, and electrolysis plant

(71) Applicant: Siemens Energy Global GmbH & Co. KG, München (DE)

(72) Inventors: Marc Hanebuth, Nürnberg (DE); Mirjam Rogler, Erlangen (DE); Richard Wagner, Effeltrich (DE)

(21) Appl. No.: 18/841,777

(22) PCT Filed: Jan. 5, 2023
(86) PCT No.: PCT/EP2023/050139

§ 371 Date: Aug. 27, 2024

(30) Foreign Application Priority Data
Mar. 15, 2022 (DE) 10 2022 202 552.0

(51) Int. Cl. C25B 1/04; C25B 9/19; C25B 15/027; C25B 15/031; C25B 15/033; C25B 15/08

(52) U.S. Cl. CPC C25B 1/04; C25B 9/19; C25B 15/027; C25B 15/031; C25B 15/033; C25B 15/083

(57) ABSTRACT

The invention relates to a method for operating an electrolysis plant having an electrolyser for generating hydrogen (H2) and oxygen (O2) as product gases, with water being supplied as starting material and being split at a proton-permeable membrane into hydrogen (H2) and oxygen (O2), a product gas stream being formed in a phase mixture comprising water (H2O) and a relevant product gas, and a product gas stream being supplied to a gas separator arranged downstream of the electrolyser, characterized in that the fluoride release of the membrane is determined on the basis of the operating time, the temporal progression of the fluoride concentration being ascertained, with a measure for the operation-induced degradation of the proton-permeable membrane being ascertained as the result of a release of fluoride. The invention furthermore relates to a corresponding electrolysis plant and to a measuring device for carrying out the method.

### BACKGROUND

The invention relates to a method of operating an electrolysis plant comprising an electrolyzer for production of hydrogen and oxygen as product gases. The invention further relates to an electrolysis plant.

Hydrogen is nowadays produced, for example, by means of proton exchange membrane (PEM) electrolysis or alkaline electrolysis. The electrolyzers produce hydrogen and oxygen from the water supplied with the aid of electrical energy.

An electrolyzer generally has here a multitude of electrolysis cells arranged adjacent to one another. By means of water electrolysis, water is split into hydrogen and oxygen in the electrolysis cells. In the case of a PEM electrolyzer, for example, demineralized water is typically supplied as reactant on the anode side and split into hydrogen and oxygen at a proton-permeable membrane (“proton exchange membrane”; PEM). The water is oxidized here to oxygen at the anode. The protons pass through the proton-permeable membrane. Hydrogen is produced on the cathode side. The water is generally conveyed here from a bottom side into the anode space and/or cathode space.

As well as PEM electrolysis, there are also other known forms of electrolysis, for instance alkaline electrolysis, in which other ions are transported through a membrane. For the sake of simplicity, in the context of the present invention, reference is therefore made to protons by way of example, for example by the term “proton-permeable”. In current research, there are other types of electrolyzers in which other ions, e.g. hydroxide ions, pass selectively through the membrane and hence enable charge transport for the electrolysis reaction. The general problem underlying the invention can likewise be applied to this type of electrolyzers. Therefore, the protons mentioned here are to be understood as representatives. The term “proton-permeable” should thus be understood in a much broader sense, specifically in the sense of “permeable to a particular type of ions”, especially through a membrane.

The electrolysis process takes place in what is called the electrolysis stack, composed of multiple electrolysis cells. Water is introduced as reactant into the electrolysis stack which is under DC voltage, where, after passage through the electrolysis cells, there are two exiting fluid streams consisting of water and gas bubbles (oxygen O2 or hydrogen H2). The respective separation of the water and gas phases in the fluid streams is effected in gas separators.

Hydrogen is an environmentally friendly and sustainable energy carrier. It has the unique potential to implement energy systems, transport and large parts of chemistry in a climatically benign manner and without CO2 emissions. This aim can be achieved if the hydrogen is produced by PEM electrolysis with the aid of renewable energies.

Because of the harsh electrochemical conditions that can always occur in an electrolysis, H2O2 or OH radicals can form to a minor degree within the electrolyzer, for example in the region of the cells. It is common knowledge that such species can chemically attack the membrane material of PEM electrolyzers, with such a degradation releasing fluorides as degradation products. This is because the membrane has a fluorine content and consists, for example, of PFSA, “perfluorosulfonic acid”. The membrane is a particularly important element for the functioning of the electrolysis cells in PEM electrolysis, and so the lifetime thereof and the limitation thereof by degradation effects gain significant attention, especially also from economic points of view.

In the course of continuous further development and optimization of PEM electrolyzers, the membranes should be made as thin as possible. This results in a smaller voltage drop during electrolysis, which simultaneously leads to higher efficiency. In the course of this optimization, however, it is possible to arrive at an operating regime in which the lifetime of the electrolysis cells depends on the fluoride release rate (FFR) and forms the main limiting factor. For example, it is possible to establish an end of life when 10% of the fluoride originally present in the membrane has been degraded. Therefore, it is a particular requirement to determine the amount of fluoride released from the membrane over the operation of the electrolysis plant, in order to be able to ascertain reliable lifetime predictions in the operating regime in particular. There are no known solutions to date that are reliable and simultaneously also simple from economic points of view.

Although it is possible to determine the fluoride concentration by “ex situ” analyses, sampling is automatable only with a significant level of complexity. In principle, for example, it is possible to use ion chromatography, although these devices are costly, and so their use in commercial electrolysis systems is often not an option.

The fluoride, like the protons, should be regarded here merely as a representative indicator of degradation. In current research, there are, for example, also polymer membranes that do not contain fluorine. However, these are generally also functionalized for selective charge transport, for example with sulfo groups or amino groups. The present invention can be applied to such electrolyzer types, and so the information given is representative of substances that can be used as an indicator of degradation and accordingly detected.

### SUMMARY

It is therefore the object of the invention to specify a method by which the lifetime of the membrane in an electrolysis plant is determinable reliably. A further object of the invention is to specify an electrolysis plant that enables improved operation with regard to plant efficiency and reliability.

The object directed to a method is achieved in accordance with the invention by a method of operating an electrolysis plant comprising an electrolyzer for production of hydrogen and oxygen as product gases, wherein water is supplied as reactant and is split into hydrogen and oxygen at a proton-permeable membrane, forming a product gas stream in a phase mixture comprising water and a respective product gas, and with supply of a product gas stream to a gas separator downstream of the electrolyzer, wherein the release of fluoride from the membrane is determined over the operating time, wherein the progression of the fluoride concentration over time is ascertained, wherein a measure of the operational degradation of the proton-permeable membrane as a result of release of fluoride is ascertained.

The invention here proceeds directly from the finding that the rate of release of fluoride from the membrane is in principle a measurement parameter of good suitability and a reliable indicator for monitoring the degradation of the membrane. The basis of this is that the primary product of membrane degradation is dilute hydrofluoric acid HF. Difficulties in respect of determinability of the fluoride concentration directly by simple means and with sufficient reliability, especially in a complex electrolysis plant in continuous operation, can be overcome by an “in situ” measurement over the operating time. The integrated fluorine release rate over time is determined as absolute or relative value of degradation. For this purpose, the progression of the fluoride concentration over time is advantageously determined in the course of operation of the electrolysis plant. By virtue of the concept of an “in situ” measurement, for the determination of the progression of the fluoride release rate over time, information is available in a simple manner as to the operational streams of matter or volume flow rates, such as the reactant flow rate of water supplied, and the product streams in the phase mixture of water and product gas. A phase separation is thus established in the gas separator, such that the liquid phase, i.e. water, leads to a varying fill level in the gas separator that can be assessed and evaluated. In parallel, the release of fluoride, i.e. the concentration thereof in the streams of matter, is recorded over time with suitable sensors for measurement of concentration.

The invention therefore provides a method of inferring the fluoride concentrations in an electrolysis plant and hence of being able to infer the degradation of the membrane and the residual operating lifetime thereof. This is enabled in that the “in situ” method provides additional information that makes it possible and is utilized specifically here to balance the volume flow rates supplied to the electrolysis plant and those leaving the electrolysis plant. This concept enables integration of the fluoride release rate over time and the determination of a relative or absolute degree of degradation of the membrane. It is thus easily and reliably possible to determine the lifetime of the membrane in an electrolysis plant.

The method is very advantageous here over the solutions known to date, in which it has generally been necessary to date to use absolute volume flow rates that were not quantifiable with sufficient precision. Measurements of volume flow rate are associated with significant financial complexity in terms of procurement and maintenance.

Moreover, ion exchangers present and any other plant components of the electrolysis plant that can lower the fluoride loading of the aqueous medium and therefore distort the result had to be taken into account as well. These disadvantages are overcome by the method of the invention. This is because the fluorine release rate (FFR) of the membrane in an electrolysis plant depends on several factors, for example the operating regime (current density, temperature), possible contaminants that promote conversion of H2O2 to OH radicals, and also on the lifetime. It would be impossible with a reasonable level of complexity to seamlessly quantify the fluoride release rate for the entire lifetime of an electrolysis plant in order to use these values to conclude the lifetime of the electrolysis plant if one wished to do so by known methods.

The “in situ” method of the invention provides a remedy here and meets the need for a practicable solution with a reasonable level of complexity in that balancing is combined with a measurement of concentration over the operating time.

In one embodiment of the method, the fluoride concentration is ascertained by a measurement of the specific conductivity and/or the pH of the water in the electrolysis plant.

The basis of the determination of the fluoride release rate (FFR) is that the primary degradation product is HF, i.e. dilute hydrofluoric acid. The concentration is typically very low; the pH is above 4, often even above 5. In this range, HF is virtually completely in dissociated form. Since simultaneously the aqueous medium can be considered to be very dilute, the fluoride concentration is proportional to specific conductivity in a very good approximation, although the protons of hydrofluoric acid make by far the greatest contribution to conductivity. This is because of what is called the Grotthuss mechanism, owing to which the specific conductivity of the protons is unusually high. The result of this effect is that contaminants in the concentrations as typically occur in PEM electrolysis systems lead to a much smaller rise in specific conductivity.

Accordingly, it has been found that the method according to the invention is robust to contaminants even though a relatively simple and comparatively nonspecific test method is being employed thereby, in particular a conductivity measurement.

In one embodiment, the fluoride concentration in the electrolysis system is determined via specific conductivity, since, for reasons given above, a clear correlation has been found and it is thus a good measure of the concentration of fluoride ions. In this respect, robust and inexpensive conductivity sensors are usable, which is advantageous for implementation in an electrolysis plant. It is alternatively preferably likewise possible in principle to use pH sensors. However, since these are of more complex construction and have to be maintained more frequently, conductivity sensors are the preferred configuration over pH sensors. A further potential drawback of pH sensors with respect to conductivity sensors is that these can release potassium chloride (KCl) in operation and hence contaminate the water in the electrolysis processes. In principle, however, in the method described here, a measurement of pH can also be conducted, or else a combination of conductivity measurement and pH measurement.

In one embodiment, a fluoride release rate is determined in that a change in the fill level in the gas separator over time is ascertained and this is used to quantify the volume flow rates, from which a measure of the cumulative degradation over time as a result of release of fluoride is determined.

As a result, the requisite balancing of the streams of matter which is likewise proposed here as well as the “in situ” measurement of the fluoride concentration can be conducted particularly advantageously and in a simple manner in operation via a change in fill levels in the gas separator over time. It is possible here to make use of existing components and equipment in an electrolysis plant, namely the gas separator. There is no need for additional complex devices.

The fill level in the gas separator is preferably subject to closed-loop control over time between a predetermined maximum fill level and a predetermined minimum fill level, with establishment of respective phases of operation with a rising fill level and with a falling fill level. What is proposed here for the method is the observation of a variation over time, i.e. dynamic variation, or closed-loop control of the fill level. The fill level or water level in the gas separator is evaluable in a particularly simple manner, and changes over time can be brought about in a controlled manner as required for the test method and registered, and the progression over time can be recorded. By virtue of an observation over time and controlled influencing of the fill level, balancing is possible in a particularly simple manner in order to obtain a reliable measure for the degradation of the membrane together with the recording of the fluoride release rate.

In one embodiment, the volume flow rates of water conveyed through the membrane, called transfer water hereinafter, and of water discarded from the electrolysis plant are quantified separately. The volume flow rates are advantageously used for precise balancing of the water throughput in the electrolysis plant. Aside from preferred balancing of fill levels of the gas separator, it is also alternatively possible here to determine the transfer water, for example, via the electrolysis current. The transfer water in PEM electrolysis passes from the anode space (oxygen side) through the membrane into the cathode space (hydrogen side), and is roughly proportional to the current.

In one embodiment, in the event that specific conductivity goes above a particular threshold value and/or pH goes below a threshold value, a portion of the water in the gas separator is discharged and discarded. By virtue of the controlled discarding of a determinable volume of water, a purging process in the water-conducting system of the electrolysis plant is enabled, especially in the gas separator, which leads to cleaning of the water system in that fluoride-laden water is discharged having correspondingly high specific conductivity in a controlled manner. This phase is advantageously used simultaneously as measurement phase for the balancing.

In one embodiment, in the event of attainment of the minimum fill level, the discharge of water is stopped here, where demineralized water is supplied in the period of stoppage and the gas separator is filled up again until the maximum fill level is attained again.

In one embodiment of the method, alternately discharge of water is conducted in the phase of operation with falling fill level and replenishment of water in the phase of operation with rising fill level, until a predetermined minimum specific conductivity is attained. Thus, by alternate and controlled discharge of water and refilling, a purge procedure is conducted iteratively, while the correspondingly falling specific conductivity is observed and registered over time until a constant minimum specific conductivity is attained, i.e. plateau formation or “saturation” is to be observed with small changes, or no further changes at all, in the specific conductivity in the water, and a reduced or very low fluoride concentration correlated therewith.

In a further embodiment, a temperature measurement is conducted, by means of which a correction of the ascertained fluoride concentration value is conducted, so as to compensate for any temperature effect on account of the measurement that distorts the value ascertained.

In the calculation of the fluoride concentration from the measured values of specific conductivity, if required and in general, a correction or compensation is implementable. This correction term is temperature-dependent since the ion conductivity of fluoride and also of protons in aqueous solution is temperature-dependent, and therefore the temperature is advantageously likewise measured “in situ”. Application of a temperature-dependent correction term to the measurement of conductivity advantageously achieves very exact and reliable determination of conductivity, and the progression thereof over time is accurately appreciable and registrable.

The object directed to an electrolysis plant is achieved in accordance with the invention by an electrolysis plant comprising an electrolyzer for production of hydrogen and oxygen as product gases, having a proton-permeable membrane and having a gas separator downstream of the electrolyzer, comprising a measurement device for determination of the fluoride concentration and a closed-loop fill level controller by means of which the release of fluoride from the membrane is determinable over the period of operation, where the progression of the fluoride concentration over time can be determined, such that a measure of operational degradation of the proton-permeable membrane owing to release of fluoride is determinable.

In one embodiment, the measurement device has a conductivity sensor disposed at a site with high pressure during operation of the plant, especially at the lowest possible geodetic site. This avoids distortion of test results in the case of measurement of conductivity in operation of the electrolysis plant, since there can be a risk of degassing of dissolved constituents in water at relatively low pressure. Alternatively or additionally, it is also preferable to dispose the conductivity sensors on the pressure side of pumps.

In one embodiment, the measurement device has a pressure sensor and a temperature sensor, such that the gas moisture content in the product gas is determinable via saturation calculations.

In one embodiment, the measurement device has a flow sensor, such that the volume flow rates are determinable.

A further aspect of the invention relates to a measurement device for performance of the method according to the invention.

Advantages and advantageous configurations of the method of the invention should be regarded as advantages and advantageous configurations of the electrolysis plant and the measurement device, and vice versa.

Further advantages, features and details of the invention will be apparent from the description of preferred working examples that follows, with reference to the drawings. The features and combinations of features mentioned above in the description and the features and combinations of features mentioned hereinafter in the description of figures and/or shown solely in the individual figures are usable not only in the respectively specified combination but also in other combinations or on their own without leaving the scope of the invention.

### BRIEF DESCRIPTION OF THE DRAWINGS

Working examples of the invention are elucidated in detail by a drawing. The drawings show, in schematic and highly simplified form:

FIG. 1 illustrates an electrolysis plant with a circuit on the oxygen side;

FIG. 2 illustrates a progression of closed-loop control of the fill level within a gas separator over time;

FIG. 3 illustrates a further example of a progression of closed-loop control of the fill level within a gas separator over time; and

FIG. 4 illustrates an electrolysis plant with two circuits: one circuit on the oxygen side and one circuit on the hydrogen side.

Identical reference numerals have the same meaning in the figures.

### DETAILED DESCRIPTION

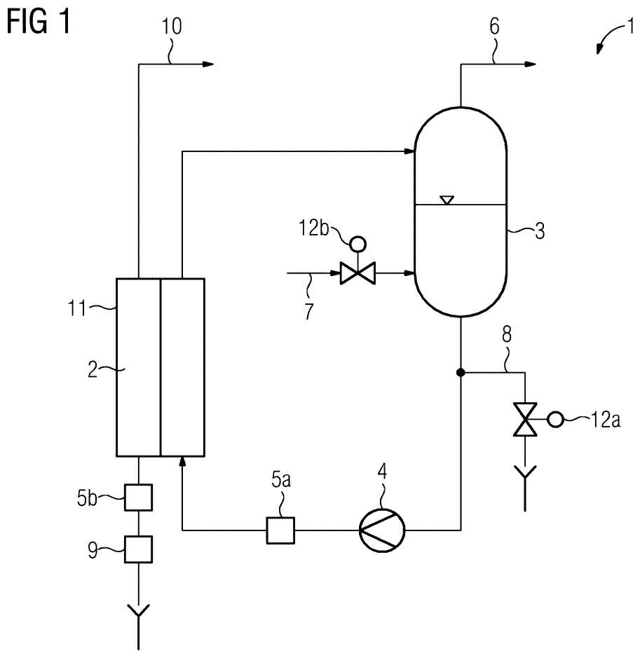

FIG. 1 shows an electrolysis plant 1 for the electrolysis of water. The electrolysis plant 1 has only one circuit on the oxygen side. This is a simple working example of an electrolysis plant 1 for execution of the invention. The electrolysis plant 1 has an electrolyzer 11 and an electrolysis cell stack 2 having a multitude of electrolysis cells stacked in axial direction that are not shown in detail. An anodic half-cell and the cathodic half-cell of an electrolysis cell are separated here by a membrane which is not shown in detail. The membrane material comprises PFSA—“perfluorosulfonic acid”.

This simple circuit supplies the electrolysis cell stack 2 with water for the electrolysis reaction, where the water simultaneously also serves for cooling of the cells. The product gas generated in the electrolysis is oxygen, which is conducted together with excess water in a phase mixture into the gas separator 3 for oxygen. A phase separation takes place in the gas separator 3, and the gaseous oxygen is separated from the liquid water and withdrawn from the circuit via the outlet 6 for the oxygen. In order to maintain the circulation of water in the circuit, the circulation pump 4 is provided in the circuit. Water consumed is compensated for by replenishing demineralized water via the feed conduit 7. Even though this is demineralized water, it would be possible for any minor impurities to accumulate in the circuit. In order to counter this effect, a magnet valve 12a is opened temporarily and a portion of the water is discarded from the circuit via the outflow conduit 8.

There is no circuit on the hydrogen side of the electrolysis plant 1 in the working example of FIG. 1. The hydrogen produced is merely led off via the outlet 10 for the hydrogen product gas and is available for further uses, for example for compression. There is typically a pressure-retaining valve disposed in the outlet 10 for the hydrogen product gas, but this is not shown in detail in the working examples. This serves to lead off the hydrogen at a certain positive pressure, which is very desirable in most applications for the further processing of the hydrogen. Since liquid water is generally obtained in the PEM electrolysis on the hydrogen side, a condensate conduit 9 is also provided, which opens when a certain amount of water has accumulated, in order to lead off this water. This may be implemented, for example, with a float. FIG. 1 indicates that this water is discarded. Alternatively, it is possible that this water is likewise utilized further for electrolysis in that it is returned to the circuit on the oxygen side. This recycling into the process is generally an approach which is pursued economically in large electrolysis plants.

In addition, a conductivity sensor 5a and a conductivity sensor 5b for measurement of specific conductivity are mounted in the electrolysis plant 1. These conductivity sensors 5a, 5b are used to conclude a particular correlation with the fluoride concentrations in the water. It is particularly advantageous here to mount the conductivity sensors 5a, 5b at sites where the pressure in the system is at a maximum since degassing of dissolved hydrogen or oxygen is particularly low or unlikely here. Gas bubbles would disrupt the precise measurement of conductivity and distort the result. Therefore, the conductivity sensors are positioned at a geodetically low point in the electrolysis plant 1 in order to exploit hydrostatic pressure benefits and hence to effectively counteract degassing.

The specific conductivities of the streams of matter, especially of the water, are used for determination of the fluoride release from the membrane over the operating time by means of the conductivity sensors 5a, 5b. The progression of the fluoride concentration is ascertained here over time, where specific conductivity is ascertained as a measure of operational degradation of the proton-permeable membrane owing to release of fluoride.

As well as the specific conductivities of the streams of matter, volume flow rates are quantified and balanced to determine the fluoride release rate. In principle, it would be possible to provide a volume flow rate sensor for each exiting water stream in order to detect these volume flow rates. However, this would be very disadvantageous since it is associated with considerable complexity in an electrolysis plant 1, especially with regard to the costs for the flow sensors and the calibration intensity in the case of relatively high proneness to error or inaccuracy.

The invention here pursues a different approach and proposes a very advantageous method wherein a change in fill levels over time within gas separators is used for the quantification of the volume flow rates.

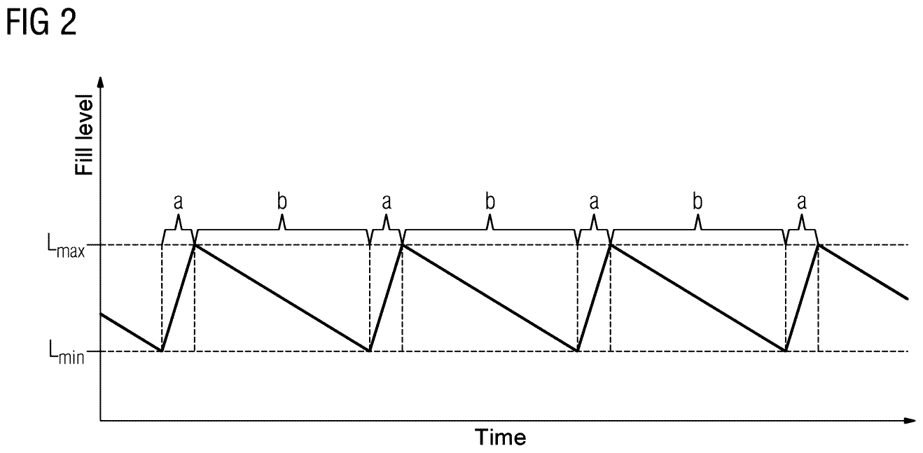

This is executed by way of example in FIG. 2, which shows a schematic diagram of the progression of the fill level within the gas separator 3 over time.

With the aid of closed-loop control of the fill level within the gas separator 3, it is ensured that, in the event that the level goes below the threshold value or lower level Lmin, demineralized water is replenished by the feed conduit 7. This is effected by the opening of the magnet valve 12b and/or the starting of a delivery pump that is not shown in detail. A corresponding rise in the fill level in the gas separator 3 is conducted during the rising phases a in the progression over time. Once a defined maximum fill level Lmax has been attained, the replenishment is ended. The fill level drops in the falling phases b in the progression over time primarily because water is firstly consumed in the electrolysis reaction by splitting into the product gases hydrogen and oxygen, and water is secondly also transported through the membrane, called the transfer water, which is transferred from the anodic half-cell to the cathodic half-cell through the membrane.

The method is advantageously an in situ method which is conducted during regular operation of the electrolysis plant 1. The fill level in the gas separator 3 here is subject to closed-loop control over time between the predetermined maximum fill level Lmax and the predetermined minimum fill level Lmin, with establishment of respective operating phases with a rising fill level a and with a falling fill level b. It is possible to execute several cycles with an operating phase with rising fill level a and falling fill level b alternately in succession, generally but not necessarily with traversal of linear transients in the progression of the fill level over time.

In order to counteract accumulation of contaminants in the circuit, a certain proportion of water is discarded from the circuit. This discarding is preferably effected by means of a continuous volume flow rate through the outflow conduit 8. The drop in the fill level in the phases b which is shown in FIG. 2 would then be caused not just by the transfer water and the electrolysis reaction but additionally by the water discarded. This would be disadvantageous to a certain degree for precise measurement and balancing of the volume flow rates in situ, since it would not be possible in this case to separately determine the volume flow rates through outflow conduit 8 and through the membrane.

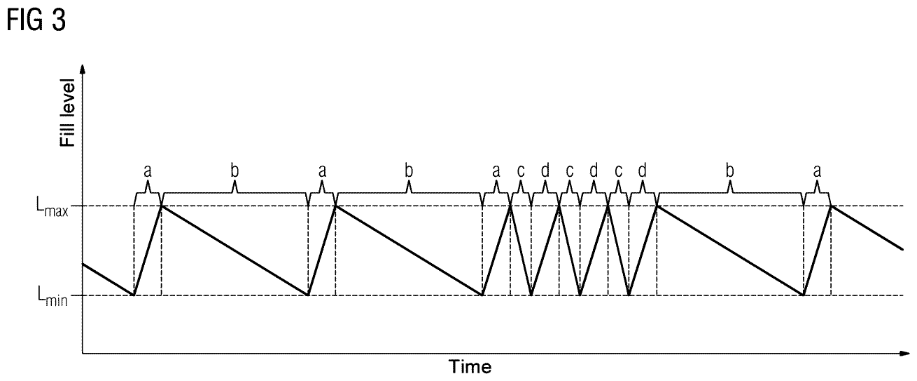

FIG. 3 shows a further example of a progression of closed-loop control of the fill level in the gas separator 3 over time, with an improved method and measurement concept compared to FIG. 2 in terms of in situ determination with exact consideration of the volume flow rates of discarded water through the outflow conduit 8 and the transfer water through the membrane of the electrolysis plant 1.

Merely by way of example, FIG. 3 illustrates here the closed-loop control concept that has been improved over FIG. 2 and the exact balancing for the fill level within the gas separator 3 with reference to FIG. 1, with which the volume flow rates of the transfer water and the discarded water can be quantified separately by the outflow conduit 9.

The underlying feature for the closed-loop control fill level system shown in FIG. 3, in the gas separator 3, is that no water is conducted out of the circuit via the outflow conduit 9 and discharged from the gas separator 3 in the phases a and b. Therefore, the magnet valve 12a closes the outflow conduit 9. The particular advantage of this method regime is that the fill level falling in the phase b in the gas separator 3 can now be attributed to the following three contributions: this is firstly the water consumed by electrochemical splitting in the electrolysis reaction. Secondly the moisture content conducted out of the process with the product gases. Finally, the transfer water that has passed through the membrane during the electrolysis.

Since the first two proportions can be calculated precisely, it is thus also possible to balance exactly how much water has passed through the membrane in a particular period. Accumulation of contaminants in the circuit is counteracted by temporary discarding of water via removal conduit 8, which is effected in FIG. 3 during the phases c.

The method is executed such that the discarding of water via the removal conduit 8 is started with exceedance of a particular threshold value of specific conductivity and stopped for a short time when a minimum fill level Lmin is attained, with replenishment of water via feed conduit 7 in this period, which corresponds to the phases d in FIG. 3. If a defined minimum specific conductivity is thus ultimately attained via the alternate purging or discharging and refilling in the phases c and d, the discarding is stopped, and electrolysis operation is continued without discarding of water.

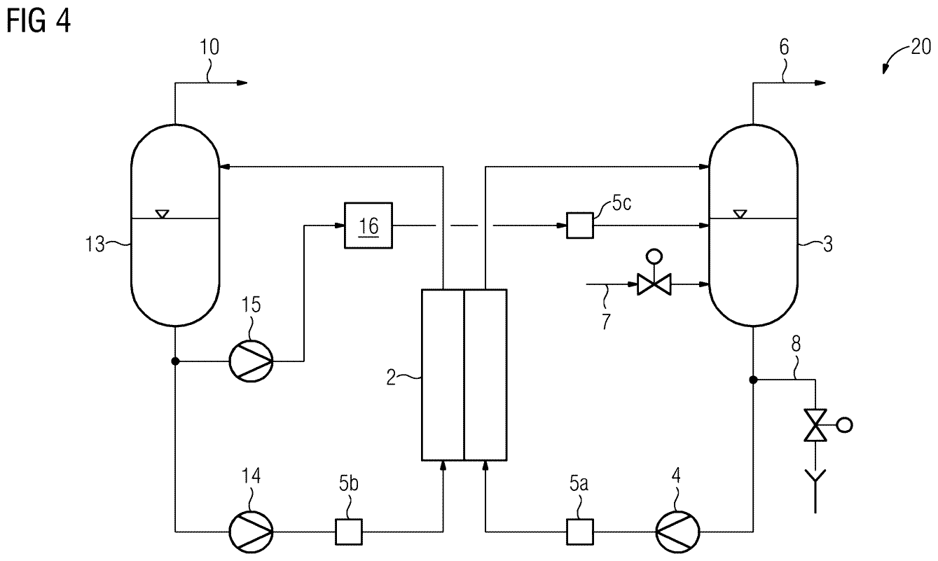

It is found to be highly advantageous that the method elucidated in FIG. 3 is also relatively easily transferable and applicable to more complex plants for water electrolysis. The method is thus largely independent of the specific plant type and is therefore flexibly adjustable. FIG. 4 shows, for example, an electrolysis plant 20 having two circuits and a water recycling operation with a water processing unit 16. The electrolysis plant 20 shown in FIG. 4 has two circuits, this time both on the oxygen side and on the hydrogen side. The gas separator 3 on the oxygen side is constructed essentially like the gas separator 3 in FIG. 1; it is also run in operation by the closed-loop control principle executed in FIG. 3. This more complex example is intended to illustrate that the invention is also applicable and easily transferable to electrolysis plants 20 having two circuits.

It is likewise possible that water processors 16, especially ion exchangers, are used in the electrolysis plant 20. It is preferable here that the specific conductivities are ascertained upstream and downstream of the water processor 16. In FIG. 4, however, no additional conductivity sensor is provided directly upstream of the water processor 16. In the plant concept of the electrolysis plant 20 with two circuits, it can be assumed that the specific conductivity in the circuit, owing to a comparatively high rate of pumped circulation via the circulation pumps 4, 14 and the transfer pump 15, virtually corresponds to the specific conductivity at the inlet of the water processor 16. There may thus be no need for the measurement point beyond the water processor 16, without any risk of drawbacks in terms of the quality of the measurement.

As well as the balancing of volume flow rates via fill level measurements, the present invention is based on measurements of specific conductivity with conductivity sensors 5a, b, 5c, in order to conclude the fluoride concentrations present in situ and ascertain the degree of membrane degradation. In principle, pH sensors are likewise suitable, although these are comparatively costly and associated with higher calibration intensity. Therefore, the electrolysis plants shown that are equipped with conductivity sensors 5a, 5b, 5c are particularly advantageous. These can advantageously be positioned particularly simply at sites with relatively high pressures or temperatures. It is particularly advantageous here to position the conductivity sensors 5a, 5b, 5c within the circuits. The alternative of providing these at outlets, for example removal conduit 8, in the batchwise operation described above, would have the effect that it would not be possible to measure the specific conductivity in the circuit in situ at any time, and there would be a risk of additional measurement inaccuracy owing to a less constant temperature. Moreover, it is particularly advantageous to position the conductivity sensors 5a, 5b, 5c at those sites in the electrolysis plant 1, 20 where there is a comparatively high pressures since the tendency to degassing at these points is lower. Gas bubbles would seriously disrupt the measurement. These points, as already set out by way of example in FIG. 1 and FIG. 4, are positioned on the pressure sides of the pumps 4, 14 or on the pressure side of a condensate diverter, or generally at a relatively low geodetic level on the basis of the hydrostatic pressure.

The present invention makes it possible, without additional complexity, to determine a fluoride release rate in high resolution over time. Only in that way is it possible to seamlessly determine the amount of fluoride released over the entire lifetime of an electrolysis plant 1, 20 and hence in the first place to reliably conclude an attained lifetime of the PFSA-containing membranes owing to spent fluoride because of degradation and to make a good prediction of residual lifetimes and available service lives. It is thus possible, for example, to very efficiently plan service measures over time and to predict future needs for replacement cells, which is beneficial to economically prolonged operation of an electrolysis plant. According to the current state, degradation of about 10% of the fluoride originally incorporated in the membrane is fixed here as the end of life in technical and economic terms. It is therefore important to know the fluoride release rate and the integral thereof over the period of operation of the plant.

1. A method of operating an electrolysis plant comprising an electrolyzer for production of hydrogen (H₂) and oxygen (O₂) as product gases, where water is supplied as reactant and is split into hydrogen (H₂) and oxygen (O₂) at a proton-permeable membrane, forming a product gas stream in a phase mixture comprising water (H₂O) and a respective product gas, and with supply of a product gas stream to a gas separator downstream of the electrolyzer, characterized in that a release of fluoride from the membrane is determined over an operating time, where a progression of a fluoride concentration over time is ascertained, where a measure of operational degradation of the proton-permeable membrane as a result of release of fluoride is ascertained.

2. The method as claimed in claim 1, in which the fluoride concentration is ascertained by a measurement of a specific conductivity and/or the pH of the water in the electrolysis plant.

3. The method as claimed in claim 1, in which a fluoride release rate is determined, where a change in a fill level in the gas separator over time is ascertained and this is used to quantify volume flow rates, from which a measure of cumulative degradation over time as a result of release of fluoride is determined.

4. The method as claimed in claim 3, in which the fill level in the gas separator is subject to closed-loop control over time between a predetermined maximum fill level (Lₘₐₓ) and a predetermined minimum fill level (Lₘᵢₙ), with establishment of respective phases of operation with a rising fill level (a, c) and with a falling fill level (b, d).

5. The method as claimed in claim 3, in which the volume flow rates of transfer water conveyed through the membrane and of water discarded from the electrolysis plant are quantified separately.

6. The method as claimed in claim 1, in which, in an event that specific conductivity goes above a particular threshold value and/or pH goes below a particular threshold value, a portion of the water in the gas separator is discharged and discarded.

7. The method as claimed in claim 6, in which, in an event of attainment of the minimum fill level (Lₘᵢₙ), the discharge of water is stopped, where demineralized water is supplied in a period of stoppage and the gas separator is filled up again until the maximum fill level (Lₘₐₓ) is attained again.

8. The method as claimed in claim 6, wherein discharge of water is conducted alternately in the phase of operation with falling fill level (b, d) and replenishment of water in the phase of operation with rising fill level (a, c), until a predetermined minimum specific conductivity is attained.

9. The method as claimed in claim 1, in which a temperature measurement is conducted, by means of which correction of the ascertained fluoride concentration value is conducted, so as to compensate for any temperature effect on account of the measurement that distorts the value ascertained.

10. An electrolysis plant comprising an electrolyzer for production of hydrogen (H₂) and oxygen (O₂) as product gases, having a proton-permeable membrane and having a gas separator downstream of the electrolyzer, comprising a measurement device for determination of a fluoride concentration and a closed-loop fill level controller by means of which a release of fluoride from the membrane is determinable over a period of operation, where a progression of the fluoride concentration over time can be determined, such that a measure of operational degradation of the proton-permeable membrane owing to release of fluoride is determinable.

11. The electrolysis plant as claimed in claim 10, in which the measurement device has a conductivity sensor disposed at a site with high pressure during operation of the plant, especially at the lowest possible geodetic site and/or on a pressure side of pumps.

12. The electrolysis plant as claimed in claim 10, in which the measurement device has a pressure sensor and a temperature sensor, such that a gas moisture content in the product gas is ascertainable via saturation calculations.

13. The electrolysis plant as claimed in claim 10, in which the measurement device has a flow sensor, such that volume flow rates are determinable.

14. (canceled)
